(19) United States
(12) Patent Application Publication
(10) Pub. No.: US 2020/0265518 A1
(43) Pub. Date: Aug. 20, 2020

(54) ICO and crowdfunding and presale payment system using alternative currency

(71) Applicants: ERICH LAWSON SPANGENBERG, PARIS (FR); DANIEL LAWRENCE BORK, EAST KINGSTON, NH (US); PASCAL ASSELOT, PARIS (FR); BRIAN JOSHUA BERMAN, LONG ISLAND CITY, NY (US)

(72) Inventors: ERICH LAWSON SPANGENBERG, PARIS (FR); DANIEL LAWRENCE BORK, EAST KINGSTON, NH (US); PASCAL ASSELOT, PARIS (FR); BRIAN JOSHUA BERMAN, LONG ISLAND CITY, NY (US)

(21) Appl. No.: 16/758,395

(22) PCT Filed: Nov. 5, 2018
(86) PCT No.: PCT/US18/59174

§ 371 Date: Apr. 22, 2020

Related U.S. Application Data
(63) Continuation-in-part of application No. 16/758,375.
Application No. PCT/US18/59174 is a continuation-in-part of application No. 16/758,384, filed on Apr. 22, 2020.
Application No. PCT/US18/59174 is a continuation-in-part of application No. 16/758,392, filed on Apr. 22, 2020.
(60) Provisional application No. 62/582,976, filed on Nov. 8, 2017.
(60) Provisional application No. 62/588,350, filed on Nov. 19, 2017.
(60) Provisional application No. 62/588,932, filed on Nov. 21, 2017.
(60) Provisional application No. 62/607,919, filed on Dec. 20, 2017.
(60) Provisional application No. 62/610,265, filed on Dec. 25, 2017.
(60) Provisional application No. 62/622,922, filed on Jan. 28, 2018.
(60) Provisional application No. 62/622,987, filed on Jan. 29, 2018.
(60) Provisional application No. 62/622,994, filed on Jan. 29, 2018.
(60) Provisional application No. 62/660,946, filed on Apr. 21, 2018.
(60) Provisional application No. 62/672,697, filed on May 17, 2018.
(60) Provisional application No. 62/685,299, filed on Jun. 15, 2018.
(60) Provisional application No. 62/685,937, filed on Jun. 16, 2018.
(60) Provisional application No. 62/685,960, filed on Jun. 16, 2018.
(60) Provisional application No. 62/689,241, filed on Jun. 24, 2018.
(60) Provisional application No. 62/695,126, filed on Jul. 8, 2018.
(60) Provisional application No. 62/696,357, filed on Jul. 11, 2018.
(60) Provisional application No. 62/575,610, filed on Oct. 23, 2017.
(60) Provisional application No. 62/576,516, filed on Oct. 24, 2017.
(60) Provisional application No. 62/577,253, filed on Oct. 26, 2017.
(60) Provisional application No. 62/579,172, filed on Oct. 31, 2017.
(60) Provisional application No. 62/579,347, filed on Oct. 31, 2017.

(51) Int. Cl. G06Q 40/04; G06F 16/23; G06Q 20/06; G06Q 10/10; G06Q 20/40; G06Q 20/42; G06Q 20/10; G06Q 20/38; G06Q 20/36; H04L 9/32; H04L 9/06

(52) U.S. Cl. CPC G06Q 40/04; H04L 2209/56; G06F 16/2365; G06Q 20/065; G06Q 10/10; G06Q 20/405; G06Q 20/42; G06Q 20/108; G06Q 20/3825; G06Q 20/4014; G06Q 20/3829; G06Q 20/3672; G06Q 20/3674; H04L 9/3247; H04L 9/0637; G06Q 2220/00; H04L 2209/38; G06F 16/2379

(57) ABSTRACT

The invention is a payment system of using any valuable asset, including fiat currency, to pay or fund an ICO, crowdfunding, or presale. Alternatively, any commodity money could be used to pay or fund an ICO, crowdfunding, or presale. Alternatively, any tangible or intangible good (such as any commodity) could be used to pay or fund an ICO, crowdfunding, or presale. A person (or company or any entity) can directly pay fiat currency to participate, pay, or fund the ICO, crowdfunding, or presale. The person can pay through any medium, such as using credit card, PayPal, check, wire transfer, calling on the phone to give credit card information, bartering, etc.

### PRIORITY CLAIMS

This application claims the benefit of U.S. Provisional Patent Application No. 62/582,976, filed Nov. 8, 2017. This application also claims the benefit of International Patent Application Number PCT/US2018/56690, filed on Oct. 19, 2018, which claims the benefit of U.S. Provisional Patent Application No. 62/575,610, filed Oct. 23, 2017. This application also claims the benefit of International Patent Application Number PCT/US2018/56884, filed on Oct. 22, 2018, which claims the benefit of U.S. Provisional Patent Application No. 62/576,516, filed Oct. 24, 2017. This application also claims the benefit of International Patent Application Number PCT/US2018/57062, filed on Oct. 23, 2018, which claims the benefit of U.S. Provisional Patent Application No. 62/577,253, filed Oct. 26, 2017, U.S. Provisional Patent Application No. 62/579,172, filed Oct. 31, 2017, and U.S. Provisional Patent Application No. 62/579,347, filed Oct. 31, 2017. This application also claims the benefit of U.S. Provisional Patent Application No. 62/588,350, filed Nov. 19, 2017. This application also claims the benefit of U.S. Provisional Patent Application No. 62/588,932, filed Nov. 21, 2017. This application also claims the benefit of U.S. Provisional Patent Application No. 62/607,919, filed Dec. 20, 2017. This application also claims the benefit of U.S. Provisional Patent Application No. 62/610,265, filed Dec. 25, 2017. This application also claims the benefit of U.S. Provisional Patent Application No. 62/622,922, filed Jan. 28, 2018. This application also claims the benefit of U.S. Provisional Patent Application No. 62/622,987, filed Jan. 29, 2018. This application also claims the benefit of U.S. Provisional Patent Application No. 62/622,994, filed Jan. 29, 2018. This application also claims the benefit of U.S. Provisional Patent Application No. 62/660,946, filed Apr. 21, 2018. This application also claims the benefit of U.S. Provisional Patent Application No. 62/672,697, filed May 17, 2018. This application also claims the benefit of U.S. Provisional Patent Application No. 62/685,299, filed Jun. 15, 2018. This application also claims the benefit of U.S. Provisional Patent Application No. 62/685,937, filed Jun. 16, 2018. This application also claims the benefit of U.S. Provisional Patent Application No. 62/685,960, filed Jun. 16, 2018. This application also claims the benefit of U.S. Provisional Patent Application No. 62/689,241, filed Jun. 24, 2018. This application also claims the benefit of U.S. Provisional Patent Application No. 62/695,002, filed Jul. 7, 2018. This application also claims the benefit of U.S. Provisional Patent Application No. 62/695,126, filed Jul. 8, 2018. This application also claims the benefit of U.S. Provisional Patent Application No. 62/696,357, filed Jul. 11, 2018, each of which is incorporated herein by reference.

### BACKGROUND

The present invention relates generally to the field of virtual currency. More specifically the present invention relates to the exchange of cryptocurrency during an Initial Coin Offering (“ICO”).

For traditional companies, there are a few ways of going about raising funds necessary for development and expansion. A company can start small and grow as its profits allow, remaining beholden only to company owners but having to wait for funds to build up. Alternately, companies can look to outside investors for early support, providing them a quick influx of cash but typically coming with the trade-off of giving away a portion of ownership stake. Another method sees companies go public, earning funds from individual investors by selling shares through an Initial Public Offering (“IPO”).

The appearance of virtual currencies such as Bitcoin introduces some new possibilities for trade and business. Bitcoin is one example of a decentralized virtual crypto-currency that is independent of any central bank. Unlike traditional currency Bitcoin is not minted ‘by fiat’, but rather mined by an interconnected network of computers.

An ICO is the cryptocurrency space's rough equivalent to an IPO in the mainstream investment world. ICOs act as fundraisers of sorts; a company looking to create a new coin, app, or service launches an ICO. Next, interested investors buy in to the offering, either with fiat currency or with preexisting digital tokens like ether. In exchange for their support, investors receive a new cryptocurrency token specific to the ICO. Investors hope that the token will perform exceptionally well into the future, providing them with a stellar return on investment. The company holding the ICO uses the investor funds as a means of furthering its goals, launching its product, or starting its digital currency. ICOs are used by startups to bypass the rigorous and regulated capital-raising process required by venture capitalists or banks.

This is the most basic definition of an ICO. However, there is much more to the method than this. Indeed, just as ICOs have come to dominate attention in the cryptocurrency and blockchain industries, so too have they brought along challenges, risks, and unforeseen opportunities.

Investors buy into ICOs in the hope of quick and powerful returns on their investments. The most successful ICOs over the past several years give investors reason to maintain this hope, as they have indeed produced tremendous returns.

When a cryptocurrency startup firm wants to raise money through an Initial Coin Offering (ICO), it usually creates a plan on a whitepaper which states what the project is about, what need(s) the project will fulfill upon completion, how much money is needed to undertake the venture, how much of the virtual tokens the pioneers of the project will keep for themselves, what type of money is accepted, and how long the ICO campaign will run for. During the ICO campaign, enthusiasts and supporters of the firm's initiative buy some of the distributed cryptocoins with fiat or virtual currency. These coins are referred to as tokens and are similar to shares of a company sold to investors in an IPO-type transaction. If the money raised does not meet the minimum funds required by the firm, the money is returned to the backers and the ICO is deemed to be unsuccessful. If the funds requirements are met within the specified timeframe, the money raised is used to either initiate the new scheme or to complete it.

ICOs are similar to IPOs and crowdfunding. Like IPOs, a stake of the startup or company is sold to raise money for the entity's operations during an ICO operation. However, while IPOs deal with investors, ICOs deal with supporters that are keen to invest in a new project much like a crowdfunding event. But ICOs differ from crowdfunding in that the backers of the former are motivated by a prospective return in their investments, while the funds raised in the latter campaign are basically donations. For these reasons, ICOs are referred to as crowdsales.

However, this investor enthusiasm also leads people astray. Because they are largely unregulated, ICOs have become a hub of frauds and scam artists, looking to prey on investors who are overzealous and underinformed.

In addition, the ability to participate in ICOs is significantly reduced since it is difficult to purchase tokens and coins during an ICO, crowdfunding, and presale. Currently, an investor wishing to participate in an ICO must go directly to the token company website to purchase their individual tokens and coins. In addition, an investor can only participate in an ICO, crowdfunding, and presale by paying with cryptocurrency.

The present invention seeks to improve in these issues be providing a method to participate in ICOs without many of the above described limitations.

### SUMMARY

An important aspect of ICOs is that they utilize a decentralized method of “token” transfer. This decentralized method of conducting transactions is known as blockchain technology. The blockchain is a data structure that stores a list of transactions and can be thought of as a distributed electronic ledger that records transactions between source identifier(s) and destination identifier(s). Every transaction is “to” a destination identifier that is associated with a public/private key pair. In creating a new transaction, outputs from other, prior transactions that are to the “from” address (which may be multiple different addresses derived from the same private key) are used as inputs for this new transaction. The new transaction is then encumbered with the public key associated with the “to” destination identifier. In other words, outputs from prior blockchain transactions are used as inputs for new transactions that are then signed using the public key associated with the destination address. The new blockchain transaction is then submitted to the blockchain. Once on the blockchain multiple such transactions are bundled into a block and the block is linked to a prior block in the “blockchain.” Computer nodes of the distributed system then maintain the blockchain and validate each new block (along with the transactions contained in the corresponding block). The techniques described herein make use of blockchain technology to address one or more problems with the conventional database systems.

Blockchain technology holds great promise for a range of industries and business cases, including the patent asset class. That is because a Blockchain can be viewed as a type of shared database, the contents of which are verified and agreed upon by a network or independent actors. For a new piece of data (such as the owner of a newly issued patent) to be added to the Blockchain, the independent verifiers must come to consensus on its validity.

Because each new set of transactions (a “block”) is cryptographically linked to the previous block, it is extraordinarily difficult to change data stored in a Blockchain and any such change would be readily detectable. Thus, blockchains are widely considered to be immutable and thus can serve as a record of proof of ownership.

When transacting in a Blockchain platform, each user makes use of a public address (needed for other actors in the network to send a transaction to that user), and a cryptographically paired “private key.” Private keys are used to sign transactions digitally, a form authentication to ensure that a given user has genuinely generated a transaction.

Blockchain is a relatively new technology. The first “real world” implementations of Blockchain, Bitcoin, envisioned by Satoshi Nakamoto launched in 2009. The Ethereum Blockchain was released in 2015. In addition to the distributed ledger capability of the Bitcoin Blockchain, the Ethereum Blockchain allows so-called “smart contracts,” which are programs stored in the Ethereum Blockchain that can act autonomously to execute sophisticated transactions.¹ ¹“Ethereum Whitepaper,” http://github.com/ethereum/wiki/wiki/white-paper, 2016

Blockchain data transfer is currently considered one the most secure technologies for digital asset transfer due to its distributed nature and use of sophisticated cryptography. Smart contracts, therefore, offer a potential solution for the management of patent transactions via the introduction of a universal, distributed ledger that does not require trust in a single third party.

The Bitcoin blockchain is limited to sets of simple information and scripts such as transaction details, and conditioning a transaction on a minimum number of signatories. It was therefore argued that for a virtual currency to truly revolutionize trade it must also provide built-in means for facilitating complex contracts and deals with the currency.

Project Ethereum builds upon Bitcoin. Not only does it allow decentralized data storage in its blockchain, Ethereum also allows storing program code on its blockchain and running it concurrently by any number of network members. By predicating release of funds upon verifiable occurrences, Ethereum enables smart contract functionality.

Basically, a network member uploads a computer program written in one of several permitted languages to the blockchain. The member may then condition the release of an amount of ETH (the currency underlying Ethereum) upon reaching the end of this program. Various network members thereafter run the program concurrently and reach a consensus on the resulted output.

The scripting languages in Ethereum or the IBM Hyperledger are Turing complete as they can implement any logic rules and initiate any calculations available.

This feature allows any member to issue and trade with a custom virtual currency upon the Ethereum network. For the sake of clarity, a custom virtual currency issued and based upon another virtual currency is referred to as a Token. A Token may have various uses. While a certain Token will represent money, another Token will represent club member points or frequent flyer points. Tokens may be traded for ETH or for any other commodities and Tokens via the Ethereum or the IBM Hyperledger network.

Before Ethereum or the IBM Hyperledger, a person was required to launch a new blockchain utilizing custom user clients and mining algorithm, in order to issue a custom decentralized virtual currency. The emergence of the Ethereum or the IBM Hyperledger network allows easy issuance of Tokens with minimal setup.

It should be mentioned that after Ethereum, several other virtual currency networks implementing smart contracts were established. Prominent examples include the IBM Hyperledger, Lisk and RootStock.

The proposed method envisions a tool powered by smart contracts, and combines several approaches from the payment industries into a blockchain format. With blockchain as the core technology, the present invention further proposes a decentralized platform (“IPWe Platform”) that is implemented as a Decentralized Application (“DApp”) that will allow each party to an ICO to transact more securely and in a less restrictive manner.

The IPWe Platform will be capable of patent registration and increasing complex transactional capabilities in a global market context. By increasing transparency, it will help to unlock additional value in this asset class and reduce the liquidity discount associated with patents.

The present invention will be capable of allowing each step of an ICO, from coin generation to valuation and release, to be recorded on the IPWe platform via a blockchain and executed with smart contracts.

Although similar to IPOs, ICOs retain at least three important structural differences from IPOs. First, ICOs are decentralized, with no single authority governing them. Second, ICOs are largely unregulated, meaning that government organizations like the U.S. Securities and Exchange Commission (SEC) do not oversee them. Finally, as a result of decentralization and a lack of regulation, ICOs are much freer in terms of structure than IPOs.

ICOs can be structured in a variety of ways. In some cases, a company sets a specific goal or limit for its funding, which means that each token sold in the ICO has a pre-set price and that the total token supply is static. In other cases, there is a static supply of ICO tokens but a dynamic funding goal, which means that the distribution of tokens to investors will be dependent upon the funds received (and that the more total funds received in the ICO, the higher the overall token price). Still other ICOs have a dynamic token supply which is determined according to the amount of funding received. In these cases, the price of a token is static, but there is no limit to the number of total tokens, save for parameters like ICO length. These different types of ICOs are illustrated below:

In an IPO, an investor receives shares of stock in a company in exchange for her investment. In the case of an ICO, there are no shares to speak of. Instead, companies raising funds via ICO provide a blockchain equivalent to a share: a cryptocurrency token. In most cases, investors pay in a popular existing token like bitcoin or ether and receive a commensurate number of new tokens in exchange.

It's worth noting just how easy it is for a company launching an ICO to make tokens. There are online services such as Token Factory that allow for the generation of cryptocurrency tokens in a matter of seconds. Investors should keep this in mind when remembering the differences between a share of stock and a token; a token does not have any inherent value. ICO managers generate tokens according to the terms of the ICO, receive them, and then distribute them per their plan by transferring them to individual investors.

Early investors in an ICO operation are usually motivated to buy cryptocoins in the hope that the plan becomes successful after it launches. If this comes to pass, the value of the tokens they purchased during the ICO will climb above the price set during the ICO itself, and they will achieve overall gains. This is the primary benefit of an ICO: the potential for amazing returns.

Indeed, ICOs have made many investors into millionaires. Take a look at the figures for 2017: That year, there were 435 successful ICOs, each raising an average of $12.7 million . . . the total amount raised for 2017 was $5.6 billion, with the 10 largest projects raising 25% of this total. Further, tokens purchased in ICOs returned an average of 12.8× the initial investment in dollar terms.

The ICO space continues to balloon at a tremendous rate. In the first quarter of 2018, ICOs brought in $6.3 billion in funds, already outpacing the entire 2017 total in just 59% as many distinct ICO projects.

As the ICO space gets bigger and bigger, so too have the largest ICOs in history. When evaluating ICOs by size, one can consider both the amount of money raised in the ICO as well as the return on investment. Sometimes ICOs with a remarkable return on investment are not among the highest-earning projects, and vice versa. Ethereum's ICO in 2014 was an early pioneer, raising $18 million over a period of 42 days. Ethereum has proven to be crucial for the ICO space in general, thanks to its innovations with regard to decentralized apps (DApps). When it debuted, ether was priced at around $0.30; as of Jul. 24, 2018, it trades at $474.62, marking gains of close to 1,600×.

In 2015, a two-phase ICO began for the company Antshares, which later rebranded to become NEO. The first phase of the ICO ended in October of 2015, and the second continued all the way until September of 2016. During this time, NEO earned about $4.5 million. While it is not one of the largest ICOs in terms of money raised, it has provided exceptional ROI for many early investors. The price of NEO at the time of the ICO was about 3 cents, and at its peak it traded at roughly $50, marking an increase in price of about 150,000%.

More recently, ICOs have generated significantly larger amounts in terms of total funds raised. The largest ICO by this metric is filecoin, a decentralized cloud storage project. During a one-month ICO ending in September of 2017, filecoin managed to raise about $257 million.

A list of the biggest ICOs to date includes²: https://www.cnbc.com/2018/07/13/initial-coin-offering-ico-what-are-they-how-do-they-work.html

| ICO Name | Amount raised |
|---|---|
| 1. Filecoin [Futures] | $257 million |
| 2. Tezos | $232 million |
| 3. EOS | $180 million |
| 4. SIRIN LABS Token | $157.9 million |
| 5. Bancor | $153 million |
| 6. Status | $108 million |
| 7. QASH | $105 million |
| 8. Aragon | $73 million |
| 9. Bankex | $70.6 million |
| 10. TRON | $70 million |

Investors looking to buy into ICOs should first familiarize themselves with the cryptocurrency space more broadly. In the case of most ICOs, investors must purchase tokens with pre-existing cryptocurrencies; this means that an ICO investor will need to already have a cryptocurrency wallet set up as well as some digital token holdings. The process is complex and is outlined as follows:

Sign up for a digital currency exchange. There are hundreds of different exchanges and wallets, so an investor must select between a multitude of options here.

Stock up on the currency you'll need in order to buy into the ICO.

Transfer your holdings to a digital wallet which supports them. The most important thing in this case is to make sure that your wallet will hold cryptocurrency compatible with the ICO (i.e. if the ICO requires payments in ether, your wallet must hold ether).

Be certain that you have the official page for the ICO itself. Read through the whitepaper, the terms of the ICO, and any other information that you can. When you're ready to begin, look for buttons to “enter the token sale” or “participate now.”

Register for the ICO. In order to do this, an investor must provide their public wallet address as well as some other information according to the ICO site.

On launch day, follow the site's instructions for buying into the ICO. In most cases, this involves transferring ether from your wallet to the ICO's public address. In return, an investor receives some of the ICO's cryptocurrency at a rate specified by the terms of the offering. There are additional fees associated with transferring cryptocurrencies like ether, so an investor has to keep a bit of the original token in reserve to cover these costs.

The ICO will send the new token to your cryptocurrency wallet. Depending on the wallet, an investor may need to add the token to the wallet itself so that they can send and receive transfers.

Either hold onto the new token or exchange it for an exchangeable token. Then exchange that token via USD or other digital currencies.

The company which provided the ICO may offer a service allowing an investor to transfer the token back to the previous cryptocurrency, or you may need to go to another digital currency exchange in order to make the transfer. In some cases, an investor may need to hold the token until it becomes listed on an exchange which you can access based on your region.

The present invention seeks to provide one platform that simplifies this process and allows an investor to participate in the ICO using any item of value.

In one embodiment, the present invention uses a decentralized method of token exchange on an existing platform to facilitate ICOs.

Central to this concept is the blockchain. The Bitcoin blockchain is limited to sets of simple information and scripts such as transaction details, and conditioning a transaction on a minimum number of signatories. It was therefore argued that for a virtual currency to truly revolutionize trade it must also provide built-in means for facilitating complex contracts and deals with the currency.

Project Ethereum was proposed and launched shortly thereafter. Ethereum builds upon Bitcoin. Not only does it allow decentralized data storage in its blockchain, Ethereum also allows storing program code on its blockchain and running it concurrently by any number of network members. By predicating release of funds upon verifiable occurrences, Ethereum enables smart contract functionality.

Basically, a network member uploads a computer program written in one of several permitted languages to the blockchain. The member may then condition the release of an amount of ETH (the currency underlying Ethereum) upon reaching the end of this program. Various network members thereafter run the program concurrently and reach a consensus on the resulted output.

The scripting languages in Ethereum are Turing complete as they can implement any logic rules and initiate any calculations available.

This feature allows any member to issue and trade with a custom virtual currency upon the Ethereum network. For the sake of clarity, a custom virtual currency issued and based upon another virtual currency is referred to as a Token. A Token may have various uses. While a certain Token will represent money, another Token will represent club member points or frequent flyer points. Tokens may be traded for ETH or for any other commodities and Tokens via the Ethereum network.

Before Ethereum, a person was required to launch a new blockchain utilizing custom user clients and mining algorithm, in order to issue a custom decentralized virtual currency. The emergence of the Ethereum network allows easy issuance of Tokens with minimal setup.

It should be mentioned that after Ethereum, several other virtual currency networks implementing smart contracts were established. Prominent examples include Lisk and RootStock.

With the recent ability to issue a variety of Tokens using virtual currency networks, shortcomings regarding the ability to determine the value of such Tokens were identified.

Traditionally, value of a currency is determined by the price of a transaction between willing parties. That is how FOREX exchange rates are calculated. Each currency is listed with its exchange rate to another currency.

However, there is difficulty in determining the value of a virtual token without multiple steps towards conversion to “fiat” or USD.

In light of the above described state of the art, it is clear that there is a long-standing need for a solution that employs a different approach to resolve the issues and deficiencies in existing attempted solutions in the field. Using these solutions, it is important to improve the ICO process to allow for a more robust participation and trading.

### BRIEF DESCRIPTION OF THE DRAWINGS

FIG. 1 is a flow diagram of an ICO using the IPWe platform.

FIG. 2 is a diagram of the asset exchange process of the present invention.

FIG. 3 is a diagram of the asset exchange and funding process of the present invention.

FIG. 4 depicts a diagram of the ICO evaluation, offer and funding process of the present invention.

FIG. 5 is an illustration showing the interconnection of each node in a distributed network.

### DETAILED DESCRIPTION

The present invention discloses a platform that allows for payment of funds towards an ICO crowdfunding, or presale.

### Definitions

As used in this description and the accompanying claims, the following terms shall have the meanings indicated, unless the context otherwise requires.

The term “cryptocurrency,” “token,” or “virtual token,” shall refer to a digital medium of value exchange and representation of value that is not guaranteed by a central authority, such as a government.

Cryptocurrency is often characterized by the absence of a central issuing or validating authority and by the existence of a cloud-based public ledger accessible by networked device for accounting of value ownership and transfer. Although embodiments of the present invention as represented in the examples below may refer to Bitcoin as the cryptocurrency, it should be recognized that other cryptocurrencies may be substituted for Bitcoin. Some embodiments of the present invention apply to a variety of cryptocurrencies and are not limited to just Bitcoin.

The term “system” shall refer to the components in communication for the creation of a user account, updating each user account in response to a transaction, communicating with a reserve of assets, and performing transactions with third-party asset exchanges (e.g. Bitcoin to USD etc.).

The system may be composed of one or more servers and may be organized as a distributed system wherein functionality is logically separated and require one or more processing components. The system will include at least a transaction server and can also include a reserve server, one or more asset exchange servers, a user account server etc. The system may also include one or more data storage systems, such as, a user account database, a transaction database, and a reserve database.

“Internal cryptocurrency address” shall refer to a cryptocurrency address that is associated with sub-accounts of the system and whose private key is under the control of the system. “External cryptocurrency address” shall refer to a cryptocurrency address outside of the system whose private key is not controlled by the system.

A user of the system may control both an external cryptocurrency address and an account whose sub-accounts have cryptocurrency addresses associated with the system and whose private keys are controlled by the system. Crypto currency is input to an account within the system from the external cryptocurrency address.

In embodiments of the present invention, a user may create an account with the system and transfer cryptocurrency into the system to a cryptocurrency address whose private key is under the control of the system. As such, the cryptocurrency is no longer under the control of the end user, however, the system maintains an accounting of the inputted cryptocurrency.

A real-world “asset” shall refer to fiat currency (e.g. USD, Yen, Pounds etc.), a commodity (e.g. gold, silver, etc.), a security (i.e. an equity stake of ownership of a company) or bond (an instrument of indebtedness), or another item that can be valued and then exchanged for cryptocurrency.

A “virtual asset” shall refer to a representation of an asset in digital form that is associated with an account holder's sub-account.

The virtual asset or cryptocurrency is an obligation of the system operator to the account holder (a liability). The value of the virtual asset is substantiated by a reserve of assets where the assets in the reserve correspond to the aggregate of virtual assets in the system's users' accounts.

A “virtual asset holder” is a user having an account with one or more sub-accounts with a balance of virtual assets.

The term “association or associated” shall mean that there is a relationship between objects.

An association is not necessarily an indication of ownership. For example, a user may have a system account that is associated with cryptocurrency. The association does not necessarily indicate that the user owns the cryptocurrency. In some embodiments, the association is a representation of an obligation owed to the user by the system. In some embodiments of the invention, ownership of cryptocurrency that enters the system is transferred from the user to the system. Thus, the user's account is associated with cryptocurrency, the association of which may be referred to as virtual cryptocurrency. However, the system may own the cryptocurrency.

In one embodiment of the present invention, a user can access the IPWe platform, which incorporates a payment system of using fiat currency to pay or fund an ICO, crowdfunding, or presale. Alternatively, any commodity money could be used to pay or fund an ICO, crowdfunding, or presale. Alternatively, any tangible or intangible good (such as any commodity) could be used to pay or fund an ICO, crowdfunding, or presale.

In one embodiment of the present invention, a person (or company or any entity) can directly pay fiat currency to participate, pay, or fund the ICO, crowdfunding, or presale.

In one embodiment, an investor person can invest in an ICO which allows payment through any medium, such as using credit card, PayPal, check, wire transfer, calling on the phone to give credit card information, bartering, etc.

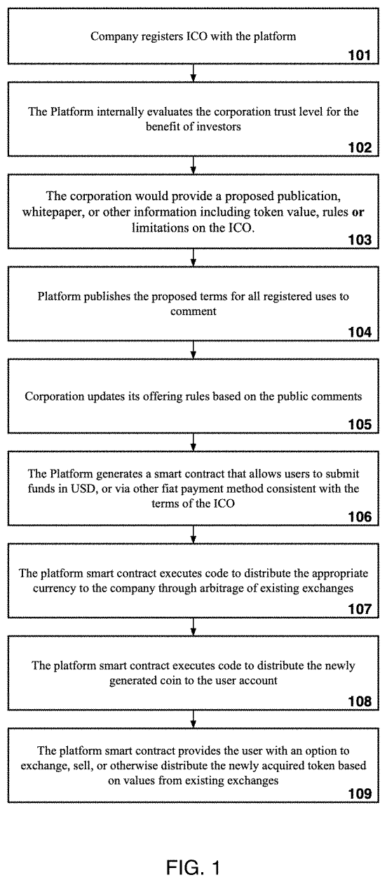

FIG. 1 is a flow diagram of an ICO using the IPWe platform. A company would register with the platform 101. The Platform internally evaluates the corporation trust level for the benefit of investors 102. The corporation would provide a proposed publication, whitepaper, or other information including token value, rules or limitations on the ICO 103. The platform would publish the proposed terms for all registered uses to comment 104. The corporation would update its offering based on the public comments 105. The Platform would generate a smart contract that allows users to submit funds in USD, or via other fiat payment method consistent with the terms of the ICO 106. The platform would issue the appropriate currency to the company through arbitrage of existing exchanges 107. The platform would distribute the newly generated coin to the user account 108. The platform would provide the user with a method to exchange, sell, or otherwise distribute the newly acquired token using arbitrage to determine value on existing indexes 109.

In one embodiment of the present invention, an investor can participate in an ICO using bartering. In a further embodiment, an investor could simply give any commodity (gold, silver, etc.), and then the token/coin issuer can value the commodity (such as USD$100,000).

In another embodiment, the platform could allow for barter in connection with investment in an ICO, and the value of a commodity could be based on any time. As an example, the time could be when the person transfers the commodity, such as the mailing date. Second, the time could be when the token company receives the commodity. Third, the time could be when the person withdraws the money/tokens from the token company. The person or the token company can choose any date, for when the equivalent value of the commodity should be priced or taken.

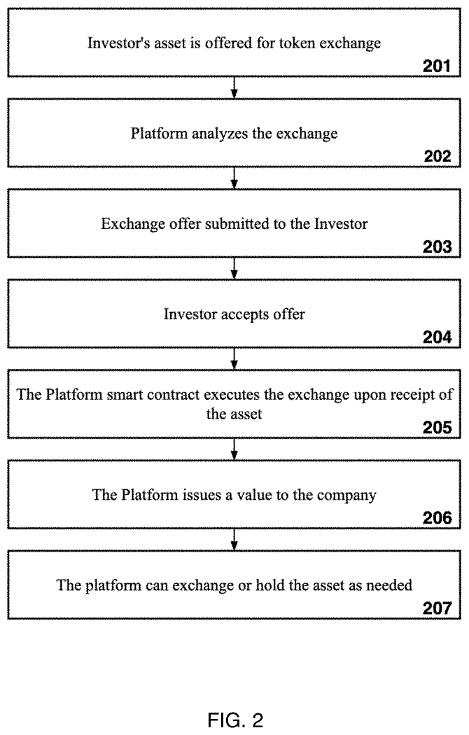

FIG. 2 is a diagram illustrating one embodiment of the present invention. An investor can offer any asset in exchange for a token 201. The platform will analyze the exchange rate for the asset 202. The platform submits the exchange offer to the investor 203. The investor may choose to accept the offer 204. If the investor accepts, a smart contract will execute the exchange upon receipt of the asset from the investor 205. The platform will issue the appropriate value to the company 206. The platform will exchange or hold the asset as needed 207. Otherwise, if the investor decides not to accept the exchange rate, the platform does not conduct the exchange.

The person can use social media, and directly pay or fund an ICO, crowdfunding, or presale through social media, such as Facebook, LinkedIn, Instagram, Twitter, etc.

In another embodiment, person does not have to go directly to the website of the token company to pay or fund an ICO, crowdfunding, or presale. A person could use any third party website (or medium) to pay or fund an ICO, crowdfunding, or presale.

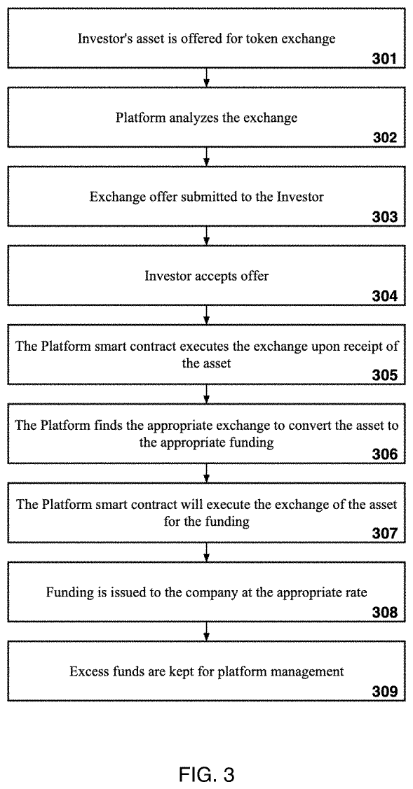

FIG. 3 is a diagram illustrating one embodiment of the present invention. An investor can offer any asset in exchange for a token 301. The platform will analyze the exchange rate for the asset 302. The platform submits the exchange offer to the investor 303. The investor may choose to accept the offer 304. If the investor accepts, a smart contract will execute the exchange upon receipt of the asset from the investor 305. The platform will automatically find the appropriate exchange to convert the asset to the appropriate funding 306. The smart contract will execute the exchange of the asset for the funding 307. The funding will be issued to the company at the appropriate rate 308. Any excess will be kept for platform management 309.

Alternatively, a person could use pre-existing tokens and coins to pay or fund an ICO, crowdfunding, or presale. A person could purchase tokens and coins for an ICO, crowdfunding, or presale directly from a digital asset broker (such as Coinbase) or from any digital asset exchange (such as Bittrex or Poloniex).

In one embodiment, an investor could use an ATM machine to directly pay or fund an ICO, crowdfunding, or presale.

In one embodiment, after the token company receives fiat currency (or any tangible or intangible good), then the token company could exchange the fiat currency for tokens. First, the token company can use arbitrage to convert the fiat currency to tokens.

In one embodiment, the token company can convert the fiat currency (or any tangible or intangible good) directly into the company's unique token, without first converting the fiat currency into a cryptocurrency, such as Bitcoin or Ethereum or Ether.

In another embodiment, the token company can first convert the fiat currency (or any tangible or intangible good) into a cryptocurrency, such as Bitcoin or Ethereum or Ether. Second, then the token company can convert the cryptocurrency into the company's unique token.

There is no timeline when the company has to convert the fiat currency (or any tangible or intangible good).

For example, the company is never required to convert the fiat currency (or any tangible or intangible good). The company may choose to simply never convert the fiat currency. For example, a person may deposit USD $100,000 into company A's token on Jan. 1, 2018. Then, on Dec. 1, 2018, the person might choose to withdraw all of their tokens from company A. The company might never have converted any of this USD $100,000 into tokens. One option would be then that the company would need to determine how much USD $100,000 is now worth on Dec. 1, 2018. The company can pay the person in any fiat currency (or any tangible or intangible good).

In one embodiment, a group of people could jointly pay or fund an ICO, crowdfunding, or presale. For example, a group of people (a family of five people) or five coworkers or five friends could pay by giving a diamond, gold, silver, fiat currency, etc. They could set it so they each get an equal 20%. Alternatively, they could set it so each person gets any set percentage, such as person 1 getting 50%, person 2 getting 20%, person 3 getting 15%, person 4 getting 8%, and person 5 getting 7%.

In one embodiment, nonhumans could participate in the ICO, crowdfunding, or presale. For example, a person could pay using fiat currency and give the ownership to their pet.

In one embodiment, nonhumans could participate in the token exchanges, such as Bittrex or Poloniex.

In one embodiment, Token exchanges could allow people to buy and sell during the ICO, crowdfunding, or presale.

In one embodiment, a person could set it up so the fiat currency or tokens are owned by a trust, will, etc.

In one embodiment, person could pay or fund an ICO, crowdfunding, presale, or token exchange (after the ICO is completed) on behalf of other people, without their permission. For example, a person could pay fiat currency as a gift for their friend or family or boyfriend or girlfriend. Verification of the person receiving the gift is not necessary. A driver license and picture of the person receiving the gift is not necessary.

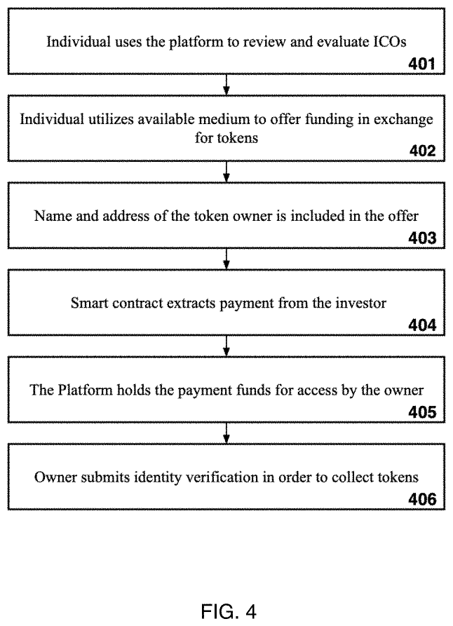

FIG. 4 depicts an illustrative diagram of one embodiment of the present invention. An individual utilizes the platform to review and evaluate ICOs 401. The individual utilizes any medium available to offer funding in exchange for tokens 402. The offer includes a specific name and address of an owner of the distributed tokens 403. The platform executes a smart contract that extracts the payment from the investor 404. The platform further holds the funds for access by the owner 405. The owner can then submit an identity verification to collect tokens at any time 406.

No verification is required by any person who is paying or funding an ICO, crowdfunding, presale, or token exchange (after the ICO is completed).

A person (or company or any entity) can directly pay fiat currency (or any tangible commodity or intangible good or commodity) to participate, pay, or fund a post-sale token exchange.

Persons of ordinary skill in the art will realize that the foregoing description is illustrative only and not in any way limiting. Other modifications and improvements will readily suggest themselves to such skilled persons having the benefit of this disclosure.

While embodiments and applications of this disclosure have been shown and described, it would be apparent to those skilled in the art that many more modifications and improvements than mentioned above are possible without departing from the inventive concepts herein. The disclosure, therefore, is not to be restricted except in the spirit of the appended claims.

The following description will refer to the implementation of mentioned above methods using smart contracts.

A computer, network, or blockchain, may deploy a smart contract. A smart contract is computer code that implements transactions of a contract. The computer code may be executed in a secure platform (e.g., an Ethereum platform) that supports recording transactions in blockchains. In addition, the smart contract itself is recorded as a transaction in the blockchain using an identity token that is a hash (i.e., identity token) of the computer code so that the computer code that is executed can be authenticated. When deployed, a constructor of the smart contract executes initializing the smart contract and its state. The state of a smart contract is stored persistently in the blockchain (e.g., via a Merkle tree). When a transaction is recorded against a smart contract, a message is sent to the smart contract and the computer code of the smart contract executes to implement the transaction (e.g., debit a certain amount from the balance of an account). The computer processes the code and ensures that all the terms of the contract are complied with before the transaction is recorded in the blockchain. For example, a smart contract may request an exchange of one type of cryptocurrency token to another. The computer executes code to determine the exchange rate and transfers the correct amount of tokens to and from the correct accounts.

Miners may manage the blockchain, whereas the managing may include, for example, validating a smart contract containing transactions according to specific rules, updating the blockchain with a validated smart contract and update the blockchain with a transaction that is executed according to the smart contract, determine that a suggested smart contract is invalid, determine that a transaction is not according to a smart contract, and the like.

In some embodiments, a smart contract may be accompanied by a digital certificate, or a digital signature which contains information regarding the source of the transaction. The computer, network, or blockchain will validate this information and determine the authenticity of the source of the transaction prior to deploying the smart contract. The smart contract may determine the rules for evaluating a token price and an initial status of the token (such as the reserve of the token) and any other rules that should be applied during a transaction. A block chain provides numerous advantages over traditional databases. A large number of nodes of a block chain may reach a consensus regarding the validity of a transaction contained on the transaction ledger.

The blockchain typically has two primary types of records. The first type is the transaction type, which consists of the actual data stored in the block chain. The second type is the block type, which are records that confirm when and in what sequence certain transactions became recorded as part of the block chain. Transactions are created by participants using the block chain in its normal course of business, for example, when someone sends cryptocurrency to another person), and blocks are created by users known as “miners” who use specialized software/equipment to create blocks. In some embodiments, the block chain system disclosed, SS the number of miners in the current system are known and the system comprises primary sponsors that generate and create the new blocks of the system. As such, any block may be worked on by a primary sponsor. Users of the block chain create transactions that are passed around to various nodes of the block chain. A “valid” transaction is one that can be validated based on a set of rules that are defined by the particular system implementing the block chain. For example, in the case of cryptocurrencies, a valid transaction is one that is digitally signed, spent from a valid digital wallet and, in some cases, that meets other criteria.

In one embodiment, the Network is made up of a plurality of nodes, each node connected to another node in the plurality of nodes, having the ability to pass data to each of the connected plurality of nodes. At least one node of the plurality of nodes is connected to an existing blockchain. Using this existing blockchain, the decentralized transactions can take place.

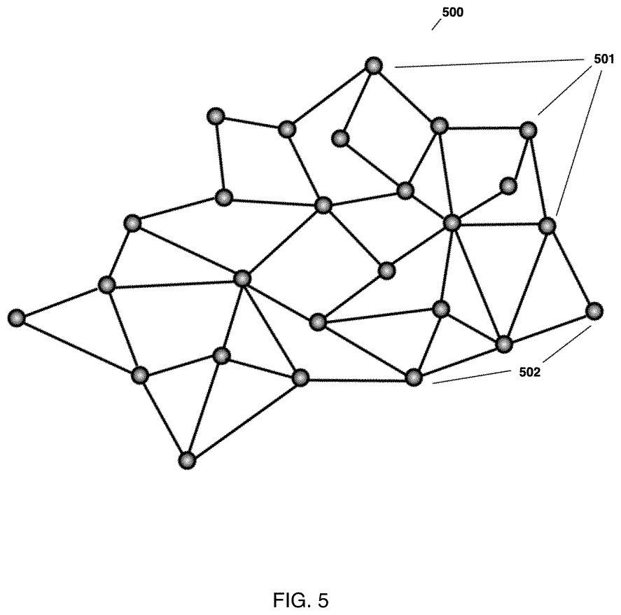

FIG. 5 depicts one aspect of the present invention. Specifically, the illustration shows the interconnection of each node 501 in a distributed decentralized network 500. In accordance with the preferred embodiment of the present invention, each node 501 in the distributed network 500 is directly connected to at least two other nodes 502. This allows each node 501 to transact with at least one other node 501 in the network.

In one embodiment, each transaction (or a block of transactions) is incorporated, confirmed, verified, included, or otherwise validated into the blockchain via a consensus protocol. Consensus is a dynamic method of reaching agreement regarding any transaction that occurs in a decentralized system. In one embodiment, a distributed hierarchical registry is provided for device discovery and communication. The distributed hierarchical registry comprises a plurality of registry groups at a first level of the hierarchical registry, each registry group comprising a plurality of registry servers. The plurality of registry servers in a registry group provide services comprising receiving client update information from client devices, and responding to client lookup requests from client devices. The plurality of registry servers in each of the plurality of registry groups provide the services using, at least in part, a quorum consensus protocol.

As another example, a method is provided for device discovery and communication using a distributed hierarchical registry. The method comprises Broadcasting a request to identify a registry server, receiving a response from a registry server, and sending client update information to the registry server. The registry server is part of a registry group of the distributed hierarchical registry, and the registry group comprises a plurality of registry servers. The registry server updates other registry servers of the registry group with the client update information using, at least in part, a quorum consensus protocol.

As another example, a computer-readable medium comprising computer executable instructions for causing a client device to perform a method for device discovery and communication is provided, the method comprising broadcasting a request to identify a registry server, receiving a response from a registry server, and sending client update information to the registry server. The registry server is part of a registry group of the distributed hierarchical registry, where the registry group comprises a plurality of registry servers. The registry server updates other registry servers of the registry group with the client update information using, at least in part, a quorum consensus protocol.

In some embodiments, the system is further able to conserve network and computing resources by securely storing information associated with user data, preventing potential malicious activity involving such information, conserving bandwidth, memory, and computation resources.

A digital wallet is software and hardware (or specifically designed hardware) that allows an individual to make electronic commerce transactions that use, a blockchain. The digital wallet is a data structure that can include a private key (e.g., that is only known to the holder of the wallet) and a series of identifiers (sometimes called wallet identifiers, blockchain identifier, or walletIDs herein) that have been generated based on the private key. These identifiers are used to allow other users to “send” transactions, which are recorded on the blockchain, to that identifier. For example, the above novation process creates two blockchain transactions for a trade between Publisher (“Party A”) and the distributed decentralized network administrator (“Party B”). A first blockchain transaction may be from the wallet of party A to the wallet of the Party B. A second blockchain transaction may be from the wallet of the Party B to a wallet of party A. These transactions may be separately generated and submitted to the blockchain. Alternatively, the blockchain may only have one “wallet” that is being used for interacting with the blockchain. Other types of implementations may also be possible (e.g., where different parties, or their respective computer systems, use their own keys for a central blockchain). In certain embodiments, the wallets may be centrally managed by the distributed decentralized network computer system that the parties associated with the trade. However, the transactions recorded to the blockchain may still be signed by or otherwise associated with the individual wallets of the patent stakeholders.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program or an operating system. The computer program may for instance include one or more of: a subroutine, a function, a procedure, an object method, an object implementation, an executable application, an applet, a servlet, a source code, an object code, a shared library/dynamic load library or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

The present technology requires a data processing system with sufficient memory and processing power to store and recall user data in real time. In addition, the invention may be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups. In particular, the distributed decentralized network discussed herein must be capable of analyzing user and bid data in a manner that can optimize the bidding process.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

In the foregoing specification, the invention has been described with reference to specific examples of embodiments of the invention. It will, however, be evident that various modifications and changes may be made therein without departing from the broader spirit and scope of the invention as set forth in the appended claims.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Any reference to “having”, “including” or “comprising” should be applied mutatis mutandis to “consisting” or “consisting essentially of”

1. A secure ledger network for distributing a virtual currency, the secure ledger network comprising:
At least one hardware processor, a non-transitory machine-readable storage medium having an executable computer readable program code, the at least one hardware processor configured to execute the computer-readable program code to:
receive, by the secure ledger network, a request to validate a smart contract that determines at least one rule for a transaction involving the distribution of the virtual currency, wherein an execution of the transaction comprises:
receiving, by the secure ledger network, a request to approve an exchange rate for at least one asset in terms of the virtual currency;
validating the exchange rate;
updating a secure ledger maintained by the secure ledger network with the smart contract;
the smart contract further configured with at least one rule regarding the exchange rate;
executing a smart contract;
updating the secure ledger about the transaction.

2. The network of claim 1, wherein the at least one asset is any item of value.

3. The network of claim 1, further capable of identifying an owner of the virtual currency.

4. The network of claim 1, further configured to transact with PayPal, credit cards, or other electronic method.

5. The network of claim 1, further configured to determine the value of the at least one asset using existing cryptocurrency exchanges.

6. The network of claim 1, further configured to use arbitrage to determine the exchange rate.

7. The network of claim 1, further configured as a decentralized network.

8. The network of claim 1, further configured as a blockchain network.

9. A secure ledger network comprising:
At least one memory device; and
at least one processing device operatively coupled to the at least one memory device, wherein the at least one processing device is configured to execute computer-readable program code to:
determine at least one rule for performing a transaction related to a virtual currency, wherein an execution comprises determining the status of the virtual currency based on the value of at least one asset;
receive, by the secure ledger network, a request to validate a smart contract that determines at least one rule for performing a transaction related to distributing the virtual currency;
receive, by the secure ledger network, a request to evaluate at least one asset in exchange for the virtual currency;
sending the investor an exchange rate for the at least one asset;
distributes the virtual currency;
updating a secure ledger about the transaction;
update a secure ledger maintained by the secure ledger network;
receive a digital signature;
verify the authenticity of the digital signature;
execute a transaction related to the virtual currency; and
update a secure ledger about a completion of the transaction.

10. The network of claim 9, wherein the asset is any item of value.

11. The network of claim 9, further capable of identifying an ownership information for the virtual currency.

12. The network of claim 9, further configured to transact with PayPal, credit cards, or other electronic method.

13. The network of claim 9, further configured to determine the value of the at least one asset using existing exchanges.

14. The network of claim 9, further configured to autonomously arbitrage the at least one asset on an exchange.

15. The network of claim 9, further configured as a decentralized network.

16. The network of claim 9, further configured as a blockchain network.

17. A blockchain network comprising a plurality of nodes, each node configured to transact with at least one other node in the plurality of nodes, the network configured to:
distribute a cryptocurrency, the network comprising:
At least one hardware processor, a non-transitory machine-readable storage medium having an executable computer readable program code, the at least one hardware processor configured to execute the computer-readable program code to:
receive, by the blockchain network, a request to exchange the cryptocurrency for at least one asset;
approving an exchange rate for the at least one asset in terms of the cryptocurrency;
validating a smart contract containing at least one rule based on exchange rate;
updating a secure ledger maintained by the blockchain network with the smart contract;
executing a smart contract that has at least one rule regarding the exchange of the at least one asset;
updating a secure ledger on the blockchain network regarding the transaction.

18. The network of claim 17, wherein the at least one asset is any item of value.

19. The network of claim 17, further capable of identifying an owner of the cryptocurrency.

20. A secure ledger network comprising:
At least one hardware processor, a non-transitory machine-readable storage medium having an executable computer readable program code, the at least one hardware processor configured to execute the computer-readable program code to:
receive, by the secure ledger network, a request to exchange at least one asset for at least one other asset;
validating the exchange rate;
updating a secure ledger maintained by the secure ledger network with a smart contract;
the smart contract further configured to execute code that contains at least one rule related to the exchange;
executing the smart contract;
updating the secure ledger on the secure ledger network regarding the transaction.

21. The network of claim 20, wherein the at least one asset is any item of value.

22. The network of claim 20, wherein the at least one other asset is any item of value.

23. The network of claim 20, further capable of identifying an owner of the at least one other asset.

24. The network of claim 20, further capable of identifying an owner of the at least other asset.

25. The network of claim 20, further configured as a decentralized network.

26. The network of claim 20, further configured as a blockchain network.
